(19) United States
(12) Patent Application Publication
(10) Pub. No.: US 2010/0190878 A1
(43) Pub. Date: Jul. 29, 2010

(54) POLYOLEFIN RESIN COMPOSITION AND FOAM MOLDED ARTICLE

(75) Inventor: Takeshi MARUYAMA, Valley Park (SG)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/642,351

(22) Filed: Dec. 18, 2009

(30) Foreign Application Priority Data
Dec. 24, 2008 (JP) 2008-327874

(51) Int. Cl. C08K 3/04; C08K 5/3435

(52) U.S. Cl. 521/90; 521/82

(57) ABSTRACT

A resin composition, comprising (A) a polyolefin resin, (B) a foaming agent, (C) a black pigment, and 0.05 to 5 parts by mass of (D) a hindered amine light stabilizer which satisfies the following requirements (a) and (b), provided that the content of the polyolefin resin (A) is let be 100 parts by mass:
requirement (a): having a 2,2,6,6-tetramethylpiperidyl group represented by formula (I) that is attached to any of a carbon atom, an oxygen atom and a nitrogen atom:

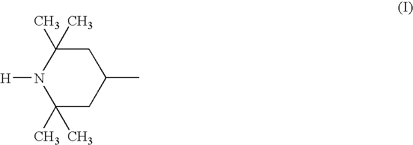

requirement (b): having an acid dissociation constant (pKa) of less than 8.

### BACKGROUND OF THE INVENTION

1. Field of the Invention

The present invention relates to a polyolefin resin composition and a foam molded article.

2. Background Art

Polypropylene resin compositions are materials excellent in rigidity, impact resistance, etc, and they, therefore, are used in a wide variety of applications in the form of molded articles such as automotive interior or exterior components and housings of electric appliances. Foam molding has been performed in order to save the weight of molded articles. In many of such molded articles of polypropylene resin compositions, from the viewpoint of high designability, products are colored by the addition of pigment. Therefore, it is necessary to inhibit occurrence of color irregularity in a molded article and many researches with respect to the occurrence of color irregularity in a molded article have been carried out.

For example, JP 10-060184 A discloses a polyolefin composition comprising a polyolefin (A) and a pigment (B), wherein the pigment (B) contains carbon black (B-1) that is produced by the furnace method and has a pH of 5 or lower and iron black (B-2) that is spherical in shape and has an average particle diameter of 0.05 to 0.25 μm. According to JP 10-060184 A, it is possible to prevent the occurrence of color irregularity, thereby obtaining a molded article having good appearance. JP 9-302099 A discloses a coloring masterbatch characterized in that 1 to 150 parts by weight of a pigment and 0.1 to 120 parts by weight of a lubricant selected from among waxes and metal soaps are incorporated in 100 parts by weight of a resin component composed of 95 to 10 parts by weight of a polypropylene and 5 to 90 parts by weight a linear low density polyethylene. According to JP 9-302099 A, it is able to obtain a molded article with no color irregularity without lowering the physical properties of the molded article.

However, the addition of a light stabilizer and a foaming agent to the above-mentioned resin composition and the following production of a foam molded article may have resulted in the occurrence of color irregularity caused by the agglomeration of the pigment due to its interaction with the foaming agent.

### SUMMARY OF THE INVENTION

In view of the problems mentioned above, an object of the present invention is to prevent the occurrence of color irregularity and obtain a foam molded article having good appearance.

The present invention provides a resin composition of foaming, comprising (A) a polyolefin resin, (B) a foaming agent, (C) a black pigment, and 0.05 to 5 parts by mass of (D) a hindered amine light stabilizer which satisfies the following requirements (a) and (b), provided that the content of the polyolefin resin (A) is let be 100 parts by mass:

requirement (a): having a 2,2,6,6-tetramethylpiperidyl group represented by formula (I) that is attached to any of a carbon atom, an oxygen atom and a nitrogen atom:

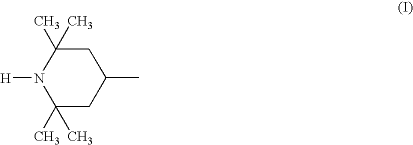

requirement (b): having an acid dissociation constant (pKa) of less than 8.

According to the present invention, it is able to inhibit the occurrence of color irregularity to obtain a foam molded article having good appearance.

### DESCRIPTION OF THE PREFERRED EMBODIMENTS

### [Polyolefin Resin Composition]

The resin composition for foaming used the present invention contains (A) a polyolefin resin, (B) a foaming agent, (C) a black pigment, and (D) a prescribed hindered amine light stabilizer.

### [(A) Polyolefin Resin]

The polyolefin resin to be used by the present invention (A) (henceforth, referred to also as component (A)) is a resin produced by polymerizing a polymerizable monomer containing an olefin monomer as a main component. The proportion of the olefin monomer in the polymerizable monomer to be used for the production of the polyolefin resin (A) is preferably 80% by weight or more, is more preferably 90% by weight or more, and the content of the structural units derived from the olefin monomer in the polyolefin resin (A) is preferably 80% by weight or more is more preferably 90% by weight or more. The olefin as referred to herein includes aliphatic unsaturated hydrocarbons having 2 to 15 carbon atoms.

Examples of the polyolefin resin (A) include homopolymers of olefins and copolymers of two or more olefins. Specific examples include a polyethylene resin, a polypropylene resin, and a polybutene resin. Among these, a polypropylene resin is preferred. As to these polyolefin resins (A), a single resin may be used or two or more resins may use in combination.

In the present invention, the term “polyethylene resin” includes not only a homopolymer of ethylene but also a copolymer of ethylene and an α-olefin. The copolymer of ethylene and an α-olefin may be either a random copolymer or a block copolymer.

Examples of the α-olefin include 1-butene, 2-methyl-1-propene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, and 1-dodecene. Especially, it is preferable to use 1-butene, 1-pentene, 1-hexene, or 1-octene.

Examples of the copolymer of ethylene and an α-olefin include an ethylene-1-butene random copolymer, an ethylene-1-pentene random copolymer, an ethylene-1-hexene random copolymer, and an ethylene-1-octene random copolymer.

In the present invention, the term “polypropylene resin” includes not only a homopolymer of propylene but also a copolymer of propylene and an α-olefin. The copolymer of propylene and an α-olefin may be either a random copolymer or a block copolymer.

Examples of the polypropylene resin include propylene hompolymers, propylene-ethylene random copolymers, propylene-α-olefin random copolymers, propylene-ethylene-α-olefin copolymers, and polypropylene-based copolymers composed of a propylene homopolymer component or a copolymer component composed mainly of propylene (henceforth, referred to also as polymer component (I)) and a copolymer component composed of propylene and ethylene and/or α-olefin (henceforth, referred to also as copolymer component (II)). As to these polypropylene resins, a resin may be used singly or two or more resins may use in combination.

Examples of the α-olefin to be used for the production of the polypropylene resin include α-olefins having 4 to 12 carbon atoms, examples of which include 1-butene, 1-pentene, 1-hexene, 4-methyl-1-pentene, 1-octene, and 1-decene. Among these, it is preferable to use 1-butene, 1-hexene, or 1-octene.

Examples of the propylene-α-olefin random copolymers include propylene-1-butene random copolymers, propylene-1-hexene random copolymers and propylene-1-octene random copolymers.

Examples of the propylene-ethylene-α-olefin copolymer include propylene-ethylene-1-butene copolymers, propylene-ethylene-1-hexene copolymers, and propylene-ethylene-1-octene copolymers.

Examples of the copolymer component composed mainly of propylene in the polymer component (I) of the polypropylene-based copolymer composed of the polymer component (I) and the copolymer component (II) include propylene-ethylene copolymer components, propylene-1-butene copolymer components, and propylene-1-hexene copolymer components. Examples of the copolymer component of propylene and ethylene and/or α-olefin (the aforementioned copolymer component (II)) include a propylene-ethylene copolymer component, a propylene-ethylene-1-butene copolymer component, a propylene-ethylene-1-hexene copolymer component, a propylene-ethylene-1-octene copolymer component, a propylene-1-butene copolymer component, a propylene-1-hexene copolymer component, and a propylene-1-octene copolymer component.

The content of ethylene and/or α-olefin in the copolymer component (II) is preferably 10 to 70% by mass.

Examples of the polypropylene-based copolymer composed of the polymer component (I) and the copolymer component (II) include a (propylene)-(propylene-ethylene) copolymer, a (propylene)-(propylene-ethylene-1-butene) copolymer, a (propylene)-(propylene-ethylene-1-hexene) copolymer, a (propylene)-(propylene-1-butene) copolymer, a (propylene)-(propylene-1-hexene) copolymer, a (propylene-ethylene)-(propylene-ethylene) copolymer, a (propylene-ethylene)-(propylene-ethylene-1-butene) copolymer, a (propylene-ethylene)-(propylene-ethylene-1-hexene) copolymer, a (propylene-ethylene)-(propylene-1-butene) copolymer, a (propylene-ethylene)-(propylene-1-hexene) copolymer, a (propylene-1-butene)-(propylene-ethylene) copolymer, a (propylene-1-butene)-(propylene-ethylene-1-butene) copolymer, a (propylene-1-butene)-(propylene-ethylene-1-hexene) copolymer, a (propylene-1-butene)-(propylene-1-butene) copolymer, and a (propylene-1-butene)-(propylene-1-hexene) copolymer.

When the polyolefin resin (A) to be used in the present invention is a polypropylene resin, it is preferable to use a propylene homopolymer, a propylene-ethylene random copolymer, a propylene-1-butene random copolymer, a propylene-ethylene-1-butene copolymer, or a (propylene)-(propylene-ethylene) copolymer as the polypropylene resin.

When the polyolefin resin (A) to be used in the present invention is a polypropylene resin, the crystallinity of the polypropylene resin may be determined suitably according to the quality that is the resin composition of the present invention or a molded article obtained by molding it is required to have.

The index of the crystallinity of the polypropylene resin is determined on the basis of a melting temperature (melting point) or a stereoregularity. The degree of stereoregularity is expressed by an isotactic index or a syndiotactic index. A polypropylene resin high in isotactic index is called an isotactic polypropylene, and a polypropylene resin high in syndiotactic index is called a syndiotactic polypropylene.

The isotactic index is a fraction of propylene monomer units that are each present at the center of an isotactic chain in the form of a pentad unit, namely a chain in which five propylene monomer units are meso-bonded successively, in the polypropylene molecular chain, as measured by a measuring method using ¹³C-NMR disclosed in A. Zambelli et al., Macromolecules, 6, 925 (1973) (the fraction is referred to as an isotactic pentad fraction and is represented by [mmmm]). The assignment of NMR absorption peaks was carried out on the basis of the article in Macromolecules 8, 687 (1975). Specifically, area fraction of mmmm peaks among all the absorption peaks within the methyl carbon region of a ¹³C-NMR spectrum is determined and it is used as an isotactic index of the polypropylene resin. It is meant that a polypropylene resin which is smaller in isotactic index is lower in crystallinity and a polypropylene resin which is higher in isotactic index is higher in crystallinity.

The syndiotactic index is determined with reference to the disclosures of J. A. Ewen, R. L. Jones, and A. Razavi: J. Am. Chem. Soc., 110, 6255 (1988) and Angew. Chem. Int. Ed. Engl. 1955, 34, 1143-1170. It is meant that a polypropylene resin which is smaller in syndiotactic index is lower in crystallinity and a polypropylene resin which is higher in isotactic index is higher in crystallinity.

The production method of the polyolefin resin (A) may be a production method using a conventionally known polymerization catalyst and a conventionally known polymerization method. Examples of the polymerization catalyst include Ziegler type catalysts and Ziegler-Natta type catalysts. Additional examples include catalyst systems composed of an alkyl aluminoxane and a compound having a cyclopentadienyl ring of a transition metal of Group 4 of the periodic table, catalyst systems composed of an organoaluminum compound, a compound having a cyclopentadienyl ring of a transition metal of Group 4 of the periodic table, and a compound capable of reacting with the transition metal compound to form an ionic complex, and catalyst systems obtained by making such catalyst systems supported on inorganic particles or the like.

Examples of the polymerization method include slurry polymerization or solvent polymerization conducted by using an inert hydrocarbon solvent, liquid phase polymerization or vapor phase polymerization conducted by using no solvent, and vapor phase-vapor phase polymerization or liquid phase-vapor phase polymerization in which these are performed successively. These polymerization methods may be performed in either a batch system or a continuous system. Moreover, the method may be either a method by which the polyolefin resin (A) is produced in a single stage or a method by which the polyolefin resin is produced in two or more stages.

Particularly, the production method of a polypropylene-based copolymer composed of the aforementioned polymer component (I) and the aforementioned copolymer component (II) is preferably a multistage production method having at least two stages including the stage of producing the polymer component (I) and the stage of producing the copolymer component (II).

The melt flow rate (henceforth, referred to also as MFR) of the polyolefin resin (A) is preferably 0.01 to 400 g/10 minutes. Adjustment of the MFR at 400 g/10 minutes or less makes it possible to render the mechanical strength of a molded article satisfactory. From the viewpoint of mechanical strength or production stability, the MFR is preferably 1 to 400 g/10 minutes, more preferably 5 to 200 g/10 minutes, and even more preferably 10 to 150 g/10 minutes. The MFR referred to in the present invention is a value measured at 230° C. and a load of 21.2 N in the case of a polypropylene or a value measured at 190° C. and a load of 21.2 N in the case of a polyethylene in accordance with ASTM D1238.

### [(B) Foaming Agent]

The resin composition according to the present invention contains (B) a foaming agent (henceforth, referred to also as component (B)). The foaming agent (B) is a chemical foaming agent, which may be any compound that is decomposed or reacts at a certain temperature with generation of gas. The chemical foaming agent may be either an organic chemical foaming agent or an inorganic chemical foaming agent. As to these foaming agent (B), a single foaming agent may be used or two or more foaming agent may use in combination.

Examples of the organic chemical foaming agent include polycarboxilic acids, azo compounds, nitroso compounds, hydrazine derivatives, and semicarbazide compounds. Examples of the inorganic chemical foaming agent include bicarbonates, carbonates, metal salts of organic acids, and nitrites.

Examples of polycarboxilic acid compounds include citric acid, oxalic acid, fumaric acid, and phthalic acid. Examples of the azo compounds include azodicarbonamide (ADCA), 1,1′-azobis(1-acetoxy-1-phenylethane), dimethyl-2,2′-azobisbutyrate, dimethyl-2,2′-azobisisobutyrate, 2,2′-azobis(2,4,4-trimethylpentane), 1,1′-azobis(cyclohexane-1-carbonitrile), and 2,2′-azobis[N-(2-carboxyethyl)-2-methyl-propioneamidine]. Examples of the nitroso compounds include N,N′-dinitrosopentamethylenetetramine (DPT). Examples of the hydrazine derivatives include 4,4′-oxybis(benzenesulfonyl hydrazide), and diphenylsulfone 3,3′-disulfonylhydrazide. Examples of the semicarbazide compounds include p-toluenesulfonyl semicarbazide. Other organic chemical foaming agents include trihydrazinotriazine.

Examples of the bicarbonates include sodium hydrogen carbonate and ammonium hydrogen carbonate. Examples of the carbonates include sodium carbonate and ammonium carbonate. Examples of the metal salts of organic acids include sodium citrate. Examples of the nitrites include ammonium nitrite.

These may be used singly or two or more members among these may be used in combination.

Among these foaming agents, a foaming agent that does not decompose at temperatures not higher than the melting temperature of the polyolefin resin (A) but decomposes at temperatures not higher than the polyolefin resin is preferably used. Specifically, azodicarbonamide (ADCA), sodium hydrogen carbonate, citric acid, and sodium citrate are preferable, and from the viewpoint of preventing the generation of an odor or the occurrence of color irregularity in a foamed article, it is more preferable that sodium hydrogen carbonate be contained.

The added amount of the foaming agent (B) is preferably 0.05 parts by mass to 5 parts by mass, and more preferably 1 part by mass to 5 parts by mass relative to 100 parts by mass of the polyolefin resin (A). Adjustment of the added amount to than the 0.05 parts by mass or more makes it possible to obtain a foam molded article having a desired expansion ratio. Adjustment of the added amount to 5 parts by mass or less makes it possible to prevent the generation of an odor or the occurrence of color irregularity in a foamed article.

It is also permissible to dilute a foaming agent with a resin to form a masterbatch and then mix and incorporate the masterbatch to the component (A). The resin used in this case is preferably a polyolefin resin, and more preferably is a polyolefin resin that has a melting temperature lower than the melting temperature of the component (A) and that has, at the time of its fusion, a viscosity lower than the viscosity which the component (A) has at the time of its fusion.

The masterbatch can be obtained by heating and melt-kneading the foaming agent and the resin by using a single screw or twin screw extruder, a Banbury mixer, a kneader, or the like. While the concentration of the component (B) contained in the masterbatch is not limited particularly, it is preferably 10 parts by mass to 80 parts by mass, provided that the overall amount of the masterbatch is let be 100 parts by mass.

### [(C) Back Pigment]

The resin composition according to the present invention contains a black pigment (C) (henceforth, referred to also as component (C)). Examples of the black pigment (C) include carbon blacks, black organic pigments, iron oxide-based black pigments, titanium-based black pigments, black inorganic pigments, perylene-based black pigments, azo pigments, coated particles having mineral black coating on the surface of a base body, and mixtures thereof.

Examples of the carbon blacks include carbon black (acetylene black, furnace black, channel black, Ketjen black, thermal black, medium thermal black, and lamp black), peach black (vegetable charcoal), bone black (bone char), Bitumen (asphalt), graphite, fullerene, and carbon nanotube. Examples of the black organic pigments include aniline black and phthalocyanine black.

Examples of the iron oxide-based black pigments include iron black, ferrite (nonmagnetic ferrite, magnetic ferrite, etc.), and magnetite.

Examples of the black inorganic pigments include copper oxide, manganese dioxide, chromium oxide, iron oxide, molybdenum disulfide, and chromium complexes. Examples of the titanium-based black pigments include titanium black, and black spinel. Examples of the perylene-based black pigments include perylene black.

Examples of the azo pigments include azo type organic pigments such as those disclosed in JP 62-138857 A or JP 3-266685 A and azo pigments disclosed in the specification of Japanese Patent No. 1726153, JP 2002-179943 A, JP 2002-256165 A, and U.S. Pat. No. 6,623,556 (B-2) number specification, and specifically include (2-hydroxy-N-(2′-methyl-4′-methoxyphenyl)-1-{[4-[(4,5,6,7-tetrachloro-1-oxo-2,3-dihydro-1H-isoindol-3-ylidene)amino]phenyl]azo}-11H-benzo[α]-carbazole 3-carboxyamide.

Examples of the coated particles having mineral black coating on the surface of a base body include near-infrared reflective coated particles composed of a black pigment coated with white pigment disclosed in JP 2002-249676 A.

Among these black pigments (C), the use of a carbon black or iron black is preferred. Among carbon blacks, the use of furnace black or channel black, which are excellent in coloring power, is preferred.

The black pigment (C) is acidic or neutral, and the PH thereof is 7.0 or less, and preferably 2.0 or higher and 7.0 or lower. Adjustment of pH to 7.0 or lower makes it possible to obtain a sufficient effect of improving the color irregularity. The pH of a black pigment is determined by the method provided in the Pigment Testing Method of JIS K5101.

The method for adjusting the pH of the black pigment (C) includes oxygen plasma treatment and surface treatment with a compound having a carbonyl group, a phosphoric acid group, or a sulfonyl group.

While the average particle diameter of the black pigment (C) is not limited particularly, it is preferably 50 nm or less, and more preferably 30 nm or less, from the viewpoint of dispersibility.

The added amount of the black pigment (C) is preferably 0.001 parts by mass to 1.0 parts by mass, more preferably 0.005 parts by mass to 0.5 parts by mass, and even more preferably 0.005 parts by mass to 0.3 parts by mass relative to 100 parts by mass of the polyolefin resin (A). Adjustment to 0.001 parts by mass or more makes it possible to show sufficient effect of improving the color irregularity. Moreover, adjustment to 1.0 parts by mass or less makes it possible to render the fluidity of a resin composition good.

As to the black pigment (C), a black pigment among those mentioned above may be used singly or two or more pigments may be used in combination. It is also permissible to dilute the black pigment with a resin to form a masterbatch and then mix and incorporate the masterbatch to the component (A). The resin used in this case is preferably a polyolefin resin, and more preferably is a polyolefin resin that has a melting temperature lower than the melting temperature of the component (A) and that has, at the time of its fusion, a viscosity lower than the viscosity which the component (A) has at the time of its fusion.

The masterbatch can be obtained by heating and melt-kneading the black pigment and the resin by using a single screw or twin screw extruder, a Banbury mixer, a kneader, or the like. While the concentration of the component (B) contained in the masterbatch is not limited particularly, it is preferably 10 parts by mass to 80 parts by mass, provided that the overall amount of the masterbatch is let be 100 parts by mass.

### [(D) Hindered Amine Light Stabilizer]

The resin composition according to the present invention contains (D) a hindered amine light stabilizer (henceforth, referred to also as component (D)).

The hindered amine light stabilizer (D) is a compound that satisfies the following requirements (a), (b), and (c):

requirement (a): having a 2,2,6,6-tetramethylpiperidyl group represented by formula (I) that is attached to any of a carbon atom, an oxygen atom and a nitrogen atom:

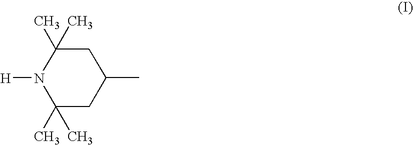

requirement (b): having an acid dissociation constant pKa of less than 8.

It is preferable that the hindered amine light stabilizer (D) further satisfy a requirement of having a molecular weight of 1000 or more (requirement (c)).

The respective requirements mentioned above are described in detail below.

With regard to requirement (a), from the viewpoint of stability to photodegradation, the group represented by formula (I) is preferably attached to either an oxygen atom or a nitrogen atom, and more preferably to a nitrogen atom.

With regard to requirement (b), from the viewpoint of stability to photodegradation and hue stability, the acid dissociation constant (pKa) of the hindered amine light stabilizer (D) is preferably less than 8, and more preferably 7 or less. The acid dissociation constant (pKa) is an index which shows an intrinsic property of a compound having a group represented by formula (I) and it is determined by conventional titration (i.e., a measuring method of an acid dissociation constant based on the Brönsted's definition).

Regarding requirement (c), the molecular weight is preferably 1000 or more, and more preferably 2000 or more from the viewpoint of mold soilage by transpiration during injection molding.

When the hindered amine light stabilizer (D) is a polymer, the number average molecular weight thereof is preferably 1000 or more, and more preferably 2000 or more.

Especially, it is preferable that a copolymer composed of a maleic acid imide derivative represented by formula (II) be contained as a structural unit:

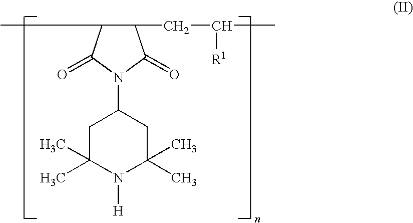

wherein R¹ represents an alkyl group having 10 to 30 carbon atoms and n represents an integer larger than 1.

The hindered amine light stabilizer (D) to be used for the present invention preferably is a light stabilizer having a structural unit represented by formula (II) wherein R¹ is an alkyl group having 14 to 28 carbon atoms, more preferably is a light stabilizer having a structural unit represented by formula (II) wherein R¹ is an alkyl group having 16 to 26 carbon atoms, and even more preferably is a light stabilizer having a structural unit represented by formula (II) wherein R¹ is an alkyl group having 18 to 22 carbon atoms. Such an alkyl group may be either a group having a linear structure or a group having a cyclic structure. Preferred are linear alkyl groups.

The added amount of the hindered amine light stabilizer (D) contained in the polypropylene resin composition of the present invention is 0.05 to 5 parts by mass, preferably 0.05 to 0.5 parts by mass, and more preferably 0.1 to 0.3 parts by mass, relative to 100 parts by mass of the polyolefin-based resin composition (A). Adjustment of the added amount of the hindered amine light stabilizer (D) to 0.05 parts by mass or more makes it possible to make a resulting foamed article have good stability to photodegradation. Adjustment of the added amount to 5 parts by mass or less makes it possible to prevent a mold from being soiled during molding and to obtain a foamed article having good appearance. The hindered amine light stabilizer (D) is used in the form of liquid, powder, granules, pellets, etc. It may also be used in the form of a composition prepared by adding it at a high concentration to components such as resin, resin additives, pigments, and so on.

The hindered amine light stabilizer (D) may be used together with another light stabilizer (including a hindered amine light stabilizer).

### [(E) Other Components]

The resin composition according to the present invention may contain, to the extent that the effect of the present invention is not impaired, additional resins or additives which are commonly incorporated in polyolefin resins. Examples of such additives include dispersants, colorants such as dyes and pigments other than the above-mentioned black pigment, fillers, nucleating agents, crystallization promoters, transparentizers, foam inhibitors, flame retarders, flame retardant aids, antistatic agents, processing aids, lubricants, antibacterial agents, organic peroxides, plasticizers, and photocatalysts such as titanium oxide. Such additives may be used singly or at least two additives may be used in combination.

Examples of such additional resins include polystyrenes, ABS (acrylonitrile/butadiene/styrene copolymerized) resins, AAS (special acrylic rubber/acrylonitrile/styrene copolymerized) resins, ACS (acrylonitrile/chlorinated polyethylene/styrene copolymerized) resins, polychloroprene, chlorinated rubbers, polyvinyl chloride, polyvinylidene chloride, acrylic resins, ethylene/vinyl alcohol copolymerized resins, fluororesins, polyacetal, grafted polyphenylene ether resins, polyphenylene sulfide resins, polyurethane, polyamide, polyester resins, polycarbonate, polysulfone, polyetheretherketone, polyethersulfone, and aromatic polyester resins, epoxy resins, diallyl phthalate prepolymers, silicone resins, silicone rubbers, polybutadiene, 1,2-polybutadiene, polyisoprene, styrene/butadiene copolymers, butadiene/acrylonitrile copolymers, epichlorohydrin rubbers, acrylic rubbers, and natural rubbers. These may be used singly or two or more members among these may be used in combination.

Examples of the polystyrenes include polyp-methylstyrene), poly(α-methylstyrene), and AS (acrylonitrile/styrene copolymerized) resins. Examples of the polyester resins include polyethylene terephthalate and polybutylene terephthalate.

Examples of the dispersants include waxes, modified waxes, metal soaps, low molecular weight polyethylene, and low molecular weight polypropylene. These may be used singly or two or more members among these may be used in combination.

Examples of waxes include paraffin wax and polyolefin wax. Examples of modified waxes include waxes having an acidic group in the molecular structure thereof. Specific examples include maleic acid-modified wax, fumaric acid-modified wax, acrylic acid-modified wax, methacrylic acid-modified wax, and crotonic acid-modified wax are listed. Sodium salts, calcium salts, zinc salts, magnesium salts and aluminum salts of fatty acids, such as stearic acid, hydroxystearic acid, behenic acid, montanic acid, lauric acid, and sebacic acid. Examples metal soaps include sodium salts, calcium salts, zinc salts, magnesium salts and aluminum salts of fatty acids, such as stearic acid, hydroxystearic acid, behenic acid, montanic acid, lauric acid, and sebacic acid.

Colorants such as inorganic pigments and organic pigments other than the aforementioned black pigments also may be incorporated. Examples of such inorganic pigments include rouge, titanium oxide, cadmium red, cadmium yellow, zinc oxide, ultramarine, cobalt blue, calcium carbonate, titanium yellow, white lead, red lead, zinc yellow, and iron blue. Examples of such organic pigments include quinacridone, polyazo yellow, anthraquinone yellow, polyazo red, azo lake yellow, perylene, phthalocyanine blue, phthalocyanine green, and isoindolinone yellow. These may be used singly or two or more members among these may be used in combination.

### [Method for Producing Resin Composition for Foaming]

The resin composition of the present invention can be obtained by kneading raw materials by using a kneading machine, such as a single screw extruder, a twin screw extruder, a Banbury mixer, and a hot roll. The addition and mixing of the respective components to the kneading machine may be carried out simultaneously or alternatively the components may be kneaded separately as described below. It is desirable that the foaming agent (B) be added during molding.

### [Foam Molded Article]

The foam molded article according to the present invention is an article obtained from a resin composition comprising a polyolefin resin (A), a foaming agent (B), a black pigment (C), and a hindered amine light stabilizer (D). The foam molded article is produced by, for example, the following methods.

Method (1): a method in which after mixing the component (A), the component (B), the component (C), and the component (D), the mixture is melt-kneaded at a temperature that is not higher than the decomposition temperature of the component (B) and not lower than the melting point of the component (A), and then the resulting composition is foam-molded.

Method (2): a method in which the component (A), the component (C) and the component (D) are melt-kneaded, and then the component (B) is added and the resulting mixture is foam-molded.

Method (3): a method in which the component (B), the component (C) and the component (D) are dry-blended to the component (A), and then the resulting mixture is foam-molded.

Possible applications of the foam molded article according to the present invention include automotive components, household electric appliance components, OA instrument components, building materials, drainage components, toiletry components, tanks, containers, and sheets.

Examples of the automotive components include interior components such as door trims, pillars, instrument panels, consoles, locker panels, arm rests, door inner panels and spare tire covers; exterior components such as bumpers, spoilers, fenders, side steps and door outer panels; other components such as air-intake ducts, coolant reserve tanks, radiator reserve tanks, window washing liquid tanks, fender liners, and fans; and integrated molded components such as front end panels.

Examples of the household electric appliance materials include washing machine materials (outer tub, inner tub, lid, pulsator, balancer, wash pan, etc.), materials of driers (housing, interior box, lid, etc.), materials of cleaners, materials of rice cookers, materials of water pots, materials of heat insulators, materials of dish washers, and materials of air cleaners.

Examples of the OA instruments and media-related materials include cases of magnetic recording media or optical recording media, personal computer components, and printer components.

Examples of the building materials include frames for solidifying concrete or the like, and wall components. Examples of the drainage components include pipes and pump parts. Examples of the container components include containers for filling foods, containers for transportation, and cloth containers. Moreover, pallets for transportation are also included in possible applications.

Especially, preferable applications of the molded article of the present invention are automotive components, household electric appliance components, building materials, drainage components, containers, and pallets for transportation.

### EXAMPLES

The present invention is described with reference to an example and comparative examples, but the invention is not limited to these examples.

The methods for measuring physical properties of the resin components and the compositions used in the example and the comparative examples are described below.

(1) Melt Flow Rate (MFR; Unit: g/10 Minutes)

The melt flow rate was measured in accordance with the method provided in JIS K7210. The measurement was carried out at a temperature of 230° C. and a load of 21.2 N unless otherwise stated.

### (2) Ethylene Content (Unit: % by Mass); (C2′)T

In the example, a polypropylene resin (propylene-(propylene-ethylene) block copolymer) was used as the polyolefin resin (A). The ethylene content in the polypropylene resin is determined by preparing a press sheet of the material to measure, measuring an infrared absorption spectrum of the sheet, and determining the content by a calibration curve method by using the obtained absorbances of the characteristic absorptions of a methyl group (—CH₃) and a methylene group (—CH₂—).

(3) Intrinsic Viscosity ([η]; Unit: dl/g)

Reduced viscosities were measured at three concentrations of 0.1, 0.2 and 0.5 g/dl using an Ubbelohde's viscometer. The intrinsic viscosity was determined by the method disclosed in “Polymer Solutions, Polymer Experiments 11” (Kobunshi Youeki, Koubunshi Jikkengaku 11), page 491 (published by Kyoritsu Publishing Co., Ltd. in 1982), namely, a method which comprises plotting reduced viscosities against concentrations and extrapolating the plotted line to a concentration of 0 (zero). As for a polypropylene, the intrinsic viscosity was measured at 135° C. using Tetralin as a solvent.

### (4) Mass Proportion X of Propylene-Ethylene Random Copolymer Portion in Propylene-(Propylene-Ethylene) Block Copolymer

The mass proportion X of a propylene-ethylene random copolymer portion in a propylene-(propylene-ethylene) block copolymer was determined by calculation from the following equation on the basis of the measurements of the crystal fusion heats of the propylene homopolymer portion and the whole block copolymer. The heat of crystal fusion was measured by using a differential scanning calorimeter (DSC).

X=1−(ΔHf)T/(ΔHf)P

(ΔHf)T: heat of fusion (cal/g) of the block copolymer

(ΔHf)P: heat of fusion (cal/g) of the propylene homopolymer portion.

### (5) Ethylene Content of Propylene-Ethylene Random Copolymer Portion in Propylene-Ethylene Block Copolymer (Unit: % by Mass)

The ethylene content of a propylene-ethylene random copolymer portion in a propylene-ethylene block copolymer was determined by calculation from the following equation by using the ethylene content (% by mass) in the block copolymer previously measured by the infrared absorption spectrum method.

(C2′)EP=(C2′)T/X

(C2′)T: ethylene content (% by mass) of the whole block copolymer

(C2′)EP: ethylene content (% by mass) of propylene-ethylene random copolymer portion.

(6) Intrinsic Viscosity of Propylene-Ethylene Random Copolymer Portion in Propylene-(Propylene-Ethylene) Block Copolymer ([η]EP, Unit: dl/g)

The intrinsic viscosity [η]EP of a propylene-ethylene random copolymer portion in a propylene-(propylene-ethylene) block copolymer was determined by calculation from the following equation on the basis of the measurements of the intrinsic viscosities of the propylene homopolymer portion and the whole block copolymer:

[η]EP=NT/X−(1/X−1)HP

[η]P: Intrinsic viscosity (dl/g) of the propylene homopolymer portion

[η]T: Intrinsic viscosity (dl/g) of the whole block copolymer.

In the production of the propylene-(propylene-ethylene) block copolymer, a propylene homopolymer, which was to become the propylene homopolymer portion of the block copolymer, was produced, and immediately after the production, some of the homopolymer was extracted from the reactor. The intrinsic viscosity of the extracted propylene homopolymer, [η]P, was measured, and the measurement was used as the intrinsic viscosity of a propylene homopolymer portion.

### (7) Average Particle Diameter

The average particle diameter was measured by an electron microscope method. The electron microscope method is a method in which carbon black is charged to chloroform and dispersed through a 20-minute irradiation with 200 KHz supersonic wave, the dispersed sample was fixed on a supporting film, the fixed sample is photographed by the use of a transmission electron microscope, and then a particle diameter is calculated from the diameter measured in the photograph and the magnification of the photograph. This operation was repeated about 1500 times and the arithmetic average of the obtained measurements was calculated.

### (8) pH Value of Black Pigment

The pH value was measured by the method provided in JIS K5101.

### (9) Evaluation of Color Irregularity

Using a flat plate having dimensions of 100 mm×400 mm×2 mm molded by the injection molding described below, whether there was a color irregularity or not was checked by visual observation.

Good: When no color irregularity was formed in a molded article, the article was judged as good (o).

Defective: When a color irregularity was formed in a molded article, the article was judged as defective (x).

In Table 1 and Table 2, sign “o” means that a color irregularity was not observed in the plate and sign “x” means that a color irregularity was observed in the plate.

### (10) Stability Against Light

A test of stability to photodegradation was carried out using a xenon weather meter (model SX75AP) manufactured by Suga Test Instruments Co., Ltd. The presence of appearance abnormality, such as cracks, in the surface of the test piece was examined after a 300 MJ irradiation. The test conditions are given below.

Dimensions of the test piece: a test piece (65 mm×150 mm×2 mm) cut from the central portion of an injection molded flat plate having dimensions of 100 mm×400 mm×3 mm (thickness) into the size of a holder of the testing machine
Amount of light irradiation: 150 w/m² (in the region of 300 nm to 400 nm)
Black panel temperature: 83° C.
Humidity in testing machine bath: 50% RH
Observation of appearance abnormalities such as cracks: observation by a light microscope (100 magnifications)

In Table 1 and Table 2, sign “o” means that no crack was observed in the surface of the test piece and sign “x” means that cracks were observed in the surface of the test piece.

### (11) Method of Preparation of Injection Molded Article

Test pieces for the evaluation of color irregularity and test pieces for the evaluation of stability to light (injection molded articles) were prepared in accordance with the following method.

As for Example 1 and Comparative Examples 1-6, a flat plate having dimensions of 100 mm×400 mm×2 mm was prepared by performing molding at a molding temperature of 230° C., a mold cooling temperature of 40° C., an injection time of 2 sec and a cooling time of 30 sec by using an injection molding machine NEOMAT [registered trademark] 350/120 manufactured by Sumitomo Heavy Industries, Ltd.

As for Examples 2-5, a flat plate having dimensions of 100 mm×400 mm×2 mm was prepared by performing molding at a molding temperature of 230° C., a mold cooling temperature of 40° C., an injection time of 6.8 sec and a cooling time of 30 sec by using an injection molding machine SE130DU [registered trademark] manufactured by Sumitomo Heavy Industries, Ltd.

### [Polyolefin Resin Composition]

### (A) Polyolefin Resin [Component (A)]

A propylene-(propylene-ethylene) block copolymer (A-1) and a polyethylene resin (A-2) were used as a polyolefin resin.

A propylene-(propylene-ethylene) block copolymer was used as a polyolefin resin. The propylene-(propylene-ethylene) block copolymer (A-1) is a polypropylene-based copolymer composed of a copolymer component composed of propylene (henceforth, referred to also as polymer component (I)) and a copolymer component composed of propylene and ethylene (henceforth, referred to also as copolymer component (II)).

The propylene-(propylene-ethylene) block copolymer was produced by liquid phase-vapor phase polymerization (multistage polymerization) using a catalyst obtainable by the method disclosed in Example 5 of JP 7-216017 A.

(A-1-1) Propylene-(propylene-ethylene) block copolymer

MFR (measured at 230° C.) of (A-1-1): 102 g/10 minutes

Ethylene content of (A-1-1): 3.7% by mass

Intrinsic viscosity of (A-1-1) ([η]Total): 1.49 dl/g

Isotactic pentad fraction of polymer component (I) of (A-1-1): 0.989

Intrinsic viscosity of polymer component (I) of (A-1-1), [η]I: 0.81 dl/g

Content of polymer component (II) in (A-1-1): 9.7% by mass

Ethylene content of polymer component (II) of (A-1-1): 38.1% by mass

Intrinsic viscosity of polymer component (II) of (A-1-1), [η]II: 7.8 dl/g

(A-1-2) Propylene-(propylene-ethylene) block copolymer

MFR (measured at 230° C.) of (A-1-2): 147 g/10 minutes

Ethylene content of (A-1-2): 3.3% by mass

Intrinsic viscosity of (A-1-2) ([η]Total): 1.27 dl/g

Isotactic pentad fraction of polymer component (I) of (A-1-2): 0.983

Intrinsic viscosity of polymer component (I) of (A-1-2), [η]I: 0.76 dl/g

Content of polymer component (II) in (A-1-2): 10.4% by mass

Ethylene content of polymer component (II) of (A-1-2): 31.7% by mass

Intrinsic viscosity of polymer component (II) of (A-1-2), [η]II: 5.76 dl/g

(A-1-3) Propylene-(propylene-ethylene) block copolymer

MFR (measured at 230° C.) of (A-1-3): 73 g/10 minutes

Ethylene content of (A-1-3): 4.2% by mass

Intrinsic viscosity of (A-1-3) ([η]Total): 1.40 dl/g

Isotactic pentad fraction of polymer component (I) of (A-1-3): 0.987

Intrinsic viscosity of polymer component (I) of (A-1-3), [η]I: 0.86 dl/g

Content of polymer component (II) in (A-1-3): 11.8% by mass

Ethylene content of polymer component (II) of (A-1-3): 35.2% by mass

Intrinsic viscosity of polymer component (II) of (A-1-3), [η]II: 5.02 dl/g

(A-2) Polyethylene resin

A commercially available random copolymers of ethylene and an α-olefin was used as a polyethylene resin.

(A-2-1) Polyethylene resin

Product name: Engage 8137, produced by The Dow Chemical Co., Ltd. (ethylene-1-octene copolymer)

(A-2-2) Polyethylene resin

Product name: Excellen CX5505, produced by Sumitomo Chemical Co., Ltd. (ethylene-1-butene copolymer)

### (B) Foaming Agent [Component (B)]

POLYTHLENE EE425 (product name, produced by Eiwa Chemical Ind. Co., Ltd., a foaming agent masterbatch containing 18.5% by mass of sodium hydrogen carbonate, 13.5% by mass of sodium citrate, and 70% by mass of a polypropylene homopolymer) was used as a foaming agent.

### (C) Black Pigment [Component (C)]

Lower grade carbon black (produced by Mitsubishi Chemical Corporation, pH=2.5, particle diameter=23 nm) was used as a black content.

### (D) Hindered Amine Light Stabilizer [Component (D)]

The following structure of (D-1) through (D-6) were used as a hindered amine light stabilizer.

(D-1) Product name UVINUL [registered trademark] 5050H, available from BASF Japan, Inc.

Sterically hindered amine oligomer “copolymer of N-(2,2,6,6-tetramethyl-4-piperidyl)maleic acid imide and a C20-24 α-olefin”

Structural Formula:

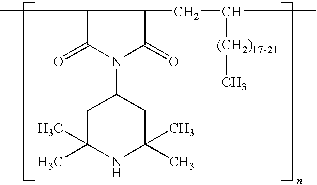

Number-average molecular weight: 3500

pKa: 7.0

(D-2) Product name ADK STAB LA52, produced by ADEKA

Chemical name: tetrakis(1,2,2,6,6-pentamethyl-4-piperidyl) 1,2,3,4-butanetetracarboxylate

Structural Formula:

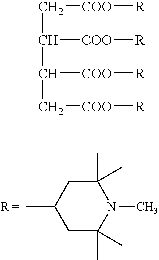

Molecular weight: 847

pKa 8.9

(D-3) Product name: TINUVIN 770DF, produced by Ciba Japan K.K.

Chemical name: Bis(2,2,6,6-tetramethyl-4-piperidyl) sebacate

Structural Formula:

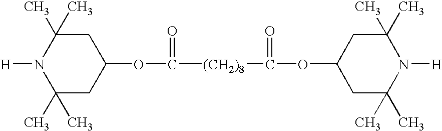

Molecular weight 481

pKa: 9.0

(D-4) Product name TINUVIN [registered trademark] 123, produced by Ciba Japan K.K.

Chemical name: Bis(1-octyloxy-2,2,6,6-tetramethylpiperidin-4-yl) sebacate

Structural Formula:

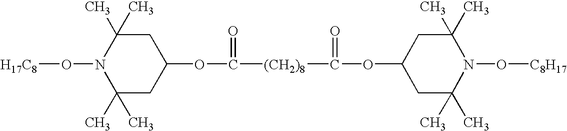

Molecular weight 737

pKa 4.4

(D-5) Product name CHIMASSORB [registered trademark] 119FL, produced by Ciba Japan K.K.

Chemical name: Condensate of N,N-bis(3-aminopropyl)ethylenediamine. 2,4-bis[N-butyl-N-(1,2,2,6,6-pentamethyl-4-pi peridyl)amino]-6-chloro-1,3,5-triazine

Structural Formula:

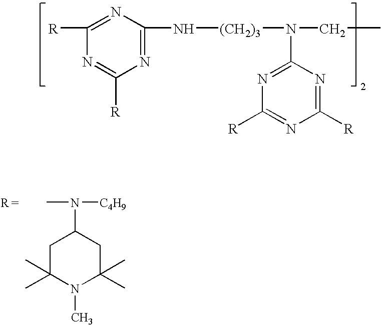

Molecular weight: 2300

pKa: 9.2

(D-6) Product name: UV3346, produced by Cytec Industries Inc.

Chemical name: Poly[(6-morpholino-s-triazine-2,4-diyl) [(2,2,6,6-tetramethyl-4-piperidyl)imino]-hexamethylene-[(2,2,6,6-tetramethyl-4-piperid yl)imino]]

Structural Formula:

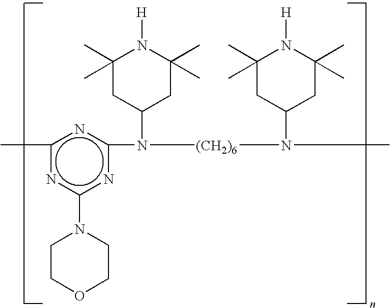

Number-average molecular weight: 1600

pKa: 9.0

### (E) Other Components

(E-1) Organic peroxide

Product name: PERHEXA 25B, produced by NOF Corporation

Chemical name: 2,5-dimethyl-2,5-di-(tert-butylperoxy)hexane)

(E-2) Neutralizing agent

Calcium stearate: produced by Kyodo Chemical Co., Ltd.

### (E-3) Antioxidant

Product name: Irgafos 168, produced by Ciba Japan K.K.

### (E-4) Antioxidant

Product name: Sumilizer GA80, produced by Sumitomo Chemical Co., Ltd.

Chemical name: 3,9-bis[2-(3-(3-tert-butyl-4-hydroxy-5-methylphenyl)propionyloxy)-1,1-dimethylethyl]-2,4,8,10-tetraoxaspiro[5-5]undecane)

### (E-5) Dispersant

Zinc stearate: produced by Nitto Kasei Kogyo Co., Ltd.

(E-6) Inorganic pigment

Titanium oxide: produced by HUNTSMAN

### Example 1

Components (A) through (E) were mixed in the proportions given in Table 1 and were stirred for 30 minutes by using a tumbler. Then, the mixture was melt-kneaded under vent suction by using a twin screw kneading extruder (TEM-50A, manufactured by Toshiba Machine Co., Ltd.), at an extrusion output of 50 kg/hr, at a screw rotation speed of 200 rpm and a cylinder setting temperature of 200° C., thereby providing a colored polypropylene resin composition.

The colored polypropylene resin composition was dried at 100° C. for 1 hour by using a hot air drier, and then component (B), which is a foaming agent, was dry-blended in an amount of 2.5 parts relative to 100 parts by mass of the colored polypropylene resin composition, and a foam molded article was obtained in accordance with the method of injection molding. The evaluation results of the resulting foam molded article are shown in Table 1.

### Example 2

A colored polypropylene resin composition was obtained in the same procedure as that of Example 1 except for using 78 parts by mass of (A-1-2) instead of 78 parts by mass of (A-1-1).

The colored polypropylene resin composition was subjected to injection foam molding in the same manner as Example 1, thereby obtaining a foam molded article. The evaluation results of the resulting foam molded article are shown in Table 1.

### Example 3

A colored polypropylene resin composition was obtained in the same procedure as that of Example 2 except for using 22 parts by mass of (A-2-2) instead of 22 parts by mass of (A-2-1). The colored polypropylene resin composition was subjected to injection foam molding in the same manner as Example 2, thereby obtaining a foam molded article. The evaluation results of the resulting foam molded article are shown in Table 1.

### Example 4

A colored polypropylene resin composition was obtained in the same procedure as that of Example 1 except for using 100 parts by mass of (A-1-2) only as Component (A).

The colored polypropylene resin composition was subjected to injection foam molding in the same manner as Example 1, thereby obtaining a foam molded article. The evaluation results of the resulting foam molded article are shown in Table 1.

### Example 5

A colored polypropylene resin composition was obtained in the same procedure as that of Example 1 except for using 100 parts by mass of (A-1-3) instead of 78 parts by mass of (A-1-1).

The colored polypropylene resin composition was subjected to injection foam molding in the same manner as Example 1, thereby obtaining a foam molded article. The evaluation results of the resulting foam molded article are shown in Table 1.

### Comparative Example 1

A colored polypropylene resin composition was obtained in the same procedure as that of Example 1 except for changing (D-1) to (D-2) as the hindered amine light stabilizer (D).

The colored polypropylene resin composition was subjected to injection foam molding in the same manner as Example 1, thereby obtaining a foam molded article. The evaluation results of the resulting foam molded article are shown in Table 2.

### Comparative Example 2

A colored polypropylene resin composition was obtained in the same procedure as that of Example 1 except for changing (D-1) to (D-3) as the hindered amine light stabilizer (D).

The colored polypropylene resin composition was subjected to injection foam molding in the same manner as Example 1, thereby obtaining a foam molded article. The evaluation results of the resulting foam molded article are shown in Table 2.

### Comparative Example 3

A colored polypropylene resin composition was obtained in the same procedure as that of Example 1 except for changing (D-1) to (D-4) as the hindered amine light stabilizer (D).

The colored polypropylene resin composition was subjected to injection foam molding in the same manner as Example 1, thereby obtaining a foam molded article. The evaluation results of the resulting foam molded article are shown in Table 2.

### Comparative Example 4

A colored polypropylene resin composition was obtained in the same procedure as that of Example 1 except for changing (D-1) to (D-5) as the hindered amine light stabilizer (D).

The colored polypropylene resin composition was subjected to injection foam molding in the same manner as Example 1, thereby obtaining a foam molded article. The evaluation results of the resulting foam molded article are shown in Table 2.

### Comparative Example 5

A colored polypropylene resin composition was obtained in the same procedure as that of Example 1 except for changing (D-1) to (D-6) as the hindered amine light stabilizer (D).

The colored polypropylene resin composition was subjected to injection foam molding in the same manner as Example 1, thereby obtaining a foam molded article.

The evaluation results of the resulting foam molded article are shown in Table 2.

### Comparative Example 6

A colored polypropylene resin composition was obtained in the same procedure as Example 1.

Injection foam molding was performed to obtain a foam molded article in the same manner as Example 1, except for adding no foaming agent (B) in performing the injection foam molding by using the colored polypropylene resin composition. The evaluation results of the resulting foam molded article are shown in Table 2.

TABLE 1

| | Example | | | | |
|---|---|---|---|---|---|
| | 1 | 2 | 3 | 4 | 5 |
| Component (A) (parts by mass) | | | | | |
| (A-1-1) | 78 | 0 | 0 | 0 | 0 |
| (A-1-2) | 0 | 78 | 78 | 100 | 0 |
| (A-1-3) | 0 | 0 | 0 | 0 | 78 |
| (A-2-1) | 22 | 22 | 0 | 0 | 22 |
| (A-2-2) | 0 | 0 | 22 | 0 | 0 |
| Component (B) (parts by mass) | 2.5 | 2.5 | 2.5 | 2.5 | 2.5 |
| Component (C) (parts by mass) | 0.05 | 0.05 | 0.05 | 0.05 | 0.05 |
| Component (D) (parts by mass) | (D-1) | (D-1) | (D-1) | (D-1) | (D-1) |
| | 0.10 | 0.10 | 0.10 | 0.10 | 0.10 |
| Component (E-1) (parts by mass) | 0.006 | 0.006 | 0.006 | 0.006 | 0.006 |
| Component (E-2) (parts by mass) | 0.03 | 0.03 | 0.03 | 0.03 | 0.03 |
| Component (E-3) (parts by mass) | 0.10 | 0.10 | 0.10 | 0.10 | 0.10 |
| Component (E-4) (parts by mass) | 0.05 | 0.05 | 0.05 | 0.05 | 0.05 |
| Component (E-5) (parts by mass) | 0.20 | 0.20 | 0.20 | 0.20 | 0.20 |
| Component (E-6) (parts by mass) | 0.50 | 0.50 | 0.50 | 0.50 | 0.50 |
| MFR (g/10 minutes) | 82 | 103 | 93 | 178 | 43 |
| Color irregularity | ◯ | ◯ | ◯ | ◯ | ◯ |
| Light stability | ◯ | ◯ | ◯ | ◯ | ◯ |
| Specific gravity | 0.83 | 0.84 | 0.84 | 0.84 | 0.83 |

TABLE 2

| | Comparative Example | | | | | |
|---|---|---|---|---|---|---|
| | 1 | 2 | 3 | 4 | 5 | 6 |
| Component (A) (parts by mass) | | | | | | |
| (A-1-1) | 78 | 78 | 78 | 78 | 78 | 78 |
| (A-1-2) | 0 | 0 | 0 | 0 | 0 | 0 |
| (A-1-3) | 0 | 0 | 0 | 0 | 0 | 0 |
| (A-2-1) | 22 | 22 | 22 | 22 | 22 | 22 |
| (A-2-2) | 0 | 0 | 0 | 0 | 0 | 0 |
| Component (B) (parts by mass) | 2.5 | 2.5 | 2.5 | 2.5 | 2.5 | 0 |
| Component (C) (parts by mass) | 0.05 | 0.05 | 0.05 | 0.05 | 0.05 | 0.05 |
| Component (D) (parts by mass) | (D-2) | (D-3) | (D-4) | (D-5) | (D-6) | (D-1) |
| | 0.10 | 0.10 | 0.10 | 0.10 | 0.10 | 0.10 |
| Component (E-1) (parts by mass) | 0.006 | 0.006 | 0.006 | 0.006 | 0.006 | 0.006 |
| Component (E-2) (parts by mass) | 0.03 | 0.03 | 0.03 | 0.03 | 0.03 | 0.03 |
| Component (E-3) (parts by mass) | 0.10 | 0.10 | 0.10 | 0.10 | 0.10 | 0.10 |
| Component (E-4) (parts by mass) | 0.05 | 0.05 | 0.05 | 0.05 | 0.05 | 0.05 |
| Component (E-5) (parts by mass) | 0.20 | 0.20 | 0.20 | 0.20 | 0.20 | 0.20 |
| Component (E-6) (parts by mass) | 0.50 | 0.50 | 0.50 | 0.50 | 0.50 | 0.50 |
| MFR (g/10 minutes) | 83 | 83 | 81 | 82 | 83 | 82 |
| Color irregularity | X | X | X | X | X | ◯ |
| Light stability | ◯ | ◯ | ◯ | ◯ | ◯ | ◯ |
| Specific gravity | 0.83 | 0.84 | 0.84 | 0.84 | 0.84 | 0.90 |

1. A resin composition, comprising (A) a polyolefin resin, (B) a foaming agent, (C) a black pigment, and 0.05 to 5 parts by mass of (D) a hindered amine light stabilizer which satisfies the following requirements (a) and (b), provided that the content of the polyolefin resin (A) is 100 parts by mass:
requirement (a): having a 2,2,6,6-tetramethylpiperidyl group represented by formula (I) that is attached to any of a carbon atom, an oxygen atom and a nitrogen atom: 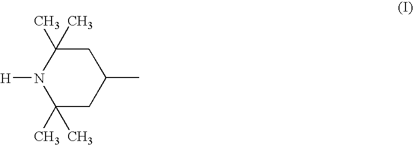
requirement (b): having an acid dissociation constant (pKa) of less than 8.

2. The resin composition according to claim 1 which contains sodium hydrogen carbonate as the foaming agent (B).

3. The resin composition according to claim 1 which contains carbon black as the black pigment (C).

4. The resin composition according to claim 1 wherein the hindered amine light stabilizer (D) satisfies requirement (c): having a molecular weight of 1000 or more.

5. The resin composition claim 1, wherein the hindered amine light stabilizer (D) is a copolymer containing a maleic acid imide derivative component represented by formula (II) as a structural unit: 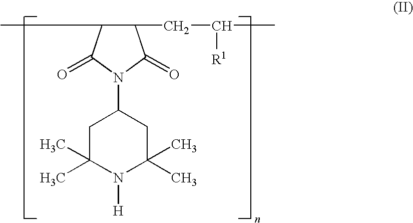
wherein R¹ represents an alkyl group having 14 to 28 carbon atoms and n represents an integer larger than 1.

6. A foam molded article produced from the resin composition according to claim 1.
